(19) United States
(12) Patent Application Publication
(10) Pub. No.: US 2012/0002587 A1
(43) Pub. Date: Jan. 5, 2012

(54) COMMUNICATION PROCESSOR AND COMMUNICATION PROCESSING METHOD

(75) Inventor: Toshiyuki KITO, Kodaira-shi (JP)

(73) Assignee: KABUSHIKI KAISHA TOSHIBA, Tokyo (JP)

(21) Appl. No.: 13/083,237

(22) Filed: Apr. 8, 2011

(30) Foreign Application Priority Data
Jun. 30, 2010 (JP) 2010-150110

(51) Int. Cl. H04W 40/00

(52) U.S. Cl. 370/315

(57) ABSTRACT

According to one embodiment, a communication processor includes a connection module, an acquisition module, and a transmitter. The connection module is capable of connecting to at least one of a communication relay device that communicates data with a communication device connected to a network and the communication device via a wireless communication line. The acquisition module acquires congestion information indicating a congestion level while the connection module is connected to the communication relay device. The transmitter transmits data to the communication device through the communication relay device when the congestion level indicated by the congestion information is lower than a predetermined level, and transmits the data to the communication device without through the communication relay device when the congestion level is equal to or higher than the predetermined level.

### CROSS-REFERENCE TO RELATED APPLICATIONS

This application is based upon and claims the benefit of priority from Japanese Patent Application No. 2010-150110, filed Jun. 30, 2010, the entire contents of which are incorporated herein by reference.

### FIELD

Embodiments described herein relate generally to a communication processor and a communication processing method.

### BACKGROUND

It has become increasingly common that a communication device is connected to a network via a wireless communication line in an environment such as office, home, and the like. Such a communication device may be connected via the wireless communication line to another communication device in the environment or in an external network. A wireless local area network (WLAN) has been proposed as a communication standard to connect communication devices in the environment. According to the WLAN standard, generally, communication devices communicate with each other via a relay device even in the environment.

Along with the recent increase of communication devices that perform WLAN communication, the load on the relay device is expected to increase. To reduce the load on the relay device, there have been proposed standards (for example, IEEE 802.11z) for direct communication between communication devices without through the relay device.

When the communication devices directly communicate with each other according to a conventional technology, they cannot be connected to the Internet. As a result, the communication devices are generally connected to the relay device, and settings need to be changed as required to allow the communication devices to directly communicate.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a network environment according to an embodiment;

FIG. 2 is an exemplary block diagram of a television (TV) receiver in the embodiment;

FIG. 3 is an exemplary schematic diagram for explaining direct communication by the TV receiver in the embodiment;

FIG. 4 is an exemplary schematic diagram of a screen displayed by a display controller in the embodiment;

FIG. 5 is an exemplary flowchart of the operation of the TV receiver to determine how to transmit a packet in the embodiment;

FIG. 6 is an exemplary flowchart of the operation of the TV receiver to transmit a packet in the embodiment;

FIG. 7 is an exemplary flowchart of the operation of the TV receiver upon receipt of a packet in the embodiment;

FIG. 8 is an exemplary flowchart of the operation of a TV receiver to transmit/receive a packet according to a modification of the embodiment; and

FIG. 9 is an exemplary block diagram of a hardware configuration of a communication device such as the TV receiver.

### DETAILED DESCRIPTION

In general, according to one embodiment, a communication processor comprises a communication processor includes a connection module, an acquisition module, and a transmitter. The connection module is configured to be capable of connecting to at least one of a communication relay device that communicates data with a communication device connected to a network and the communication device via a wireless communication line. The acquisition module is configured to acquire congestion information indicating a congestion level while the connection module is connected to the communication relay device. The transmitter is configured to transmit data to the communication device through the communication relay device when the congestion level indicated by the congestion information is lower than a predetermined level, and transmit the data to the communication device without through the communication relay device when the congestion level is equal to or higher than the predetermined level.

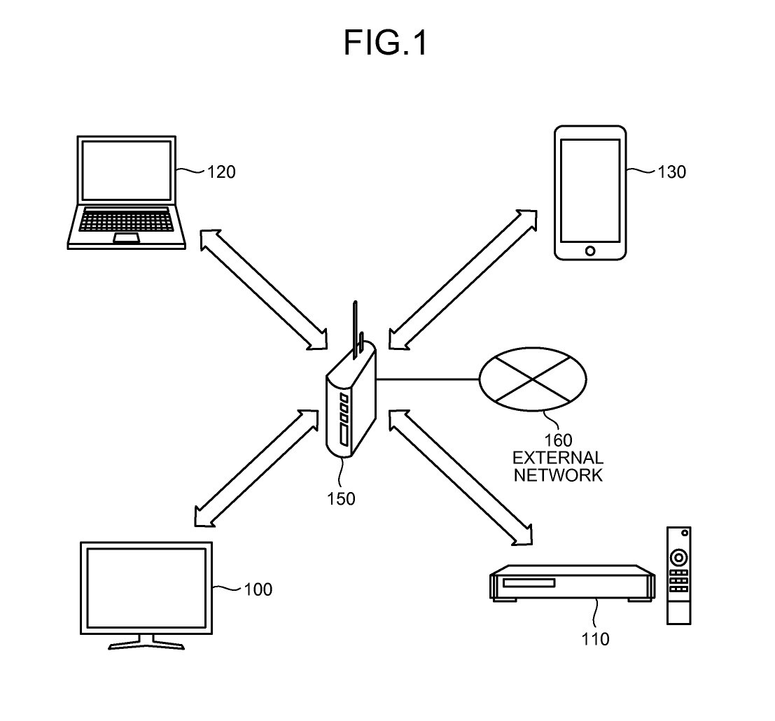

FIG. 1 illustrates an example of a network environment according to an embodiment. As illustrated in FIG. 1, a wireless relay device 150 is connected to an external network 160.

The wireless relay device 150 exchanges data with a communication device connected to a wireless communication line, thereby functioning as a wireless local area network (WLAN) access point. The communication device connected to the wireless relay device 150 via the wireless communication line can exchange data with other communication devices and the external network 160 via the wireless relay device 150.

A television (TV) receiver 100, a content recorder 110, a personal computer (PC) 120, and a mobile terminal 130 are communication devices that perform WLAN communication. The TV receiver 100, the content recorder 110, the PC 120, and the mobile terminal 130 are connected to the wireless relay device 150 via the wireless communication line to transmit/receive data.

The TV receiver 100, the content recorder 110, the PC 120, and the mobile terminal 130 are compatible with a standard (for example, IEEE 802.11z) for direct communication between communication devices.

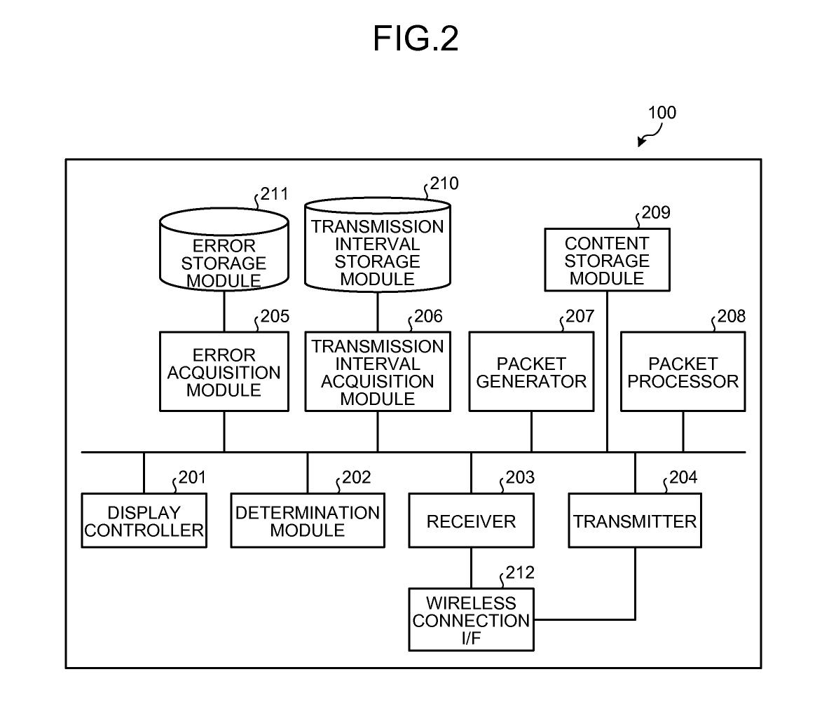

FIG. 2 is a block diagram of the TV receiver 100. As illustrated in FIG. 2, the TV receiver 100 comprises a display controller 201, a determination module 202, a receiver 203, a transmitter 204, an error acquisition module 205, a transmission interval acquisition module 206, a packet generator 207, a packet processor 208, a content storage module 209, a transmission interval storage module 210, an error storage module 211, and a wireless connection interface (I/F) 212.

The content storage module 209 stores content. Examples of content include recorded video data.

The wireless connection I/F 212 is a wireless connection interface module to connect to the wireless communication line. The wireless connection I/F 212 is capable of WLAN communication and direct communication based on the IEEE 802.11z standard. With the wireless connection I/F 212, the TV receiver 100 can be connected to at least one of a communication relay device and a communication device via the wireless communication line.

In the case of direct communication, communication devices directly communicate with each other without through the wireless relay device 150. As a result, the communication devices cannot exchange data with the external network 160. That is, if a communication device wishes to communicate data with an external network while being connected to another communication device through direct communication, the communication device needs to be connected to the wireless relay device 150. As just described, while performing direct communication, a communication device such as the TV receiver 100 is required to change the connection destination depending on where it transmits data.

The error acquisition module 205 acquires the number of retries due to communication (transmission and reception) error that occurs between the TV receiver 100 and the wireless relay device 150 while the TV receiver 100 is connected to the wireless relay device 150 via the wireless connection I/F 212. The number of retries due to communication error acquired by the error acquisition module 205 is stored in the error storage module 211.

The error storage module 211 stores the number of retries due to communication errors acquired by the error acquisition module 205 in association with the time the error occurs. With this, it is possible to know the number of communication errors that occur during a predetermined time period. This makes it possible to determine whether the processing load on the wireless relay device 150 is heavy or the communication condition with the wireless relay device 150.

The transmission interval acquisition module 206 acquires interval information indicating a time interval from when the transmitter 204 transmits a request-to-send (RTS) packet until a clear-to-send (CTS) packet is received from the wireless relay device 150 while the TV receiver 100 is connected to the wireless relay device 150 via the wireless connection I/F 212. The RTS packet is a packet indicating transmission request, while the CTS packet is a packet indicating that transmission is ready. The transmission interval acquisition module 206 stores the acquired interval information in the transmission interval storage module 210.

The transmission interval storage module 210 stores the interval information acquired by the transmission interval acquisition module 206. The TV receiver 100 of the embodiment can determine whether the processing load on the wireless relay device 150 is heavy based on the time interval of the packets.

In the embodiment, an example will be described in which the number of transmission errors and a time interval until the packet is received are acquired as congestion information indicating a congestion level; however, the congestion information indicating a congestion level in the wireless relay device 150 is not limited thereto. Other types of information may be acquired as the congestion information.

When the congestion level is lower than a predetermined reference level, the determination module 202 determines to connect the TV receiver 100 to another communication device via the wireless relay device 150. On the other hand, when the congestion level reaches the predetermined reference level, the determination module 202 determines to directly connect the TV receiver 100 to another communication device without through the wireless relay device 150.

The determination module 202 of the embodiment determines whether the number of errors that occur during the predetermined time period stored in the error storage module 211 is equal to or more than a predetermined error threshold. If the number of errors is equal to or more than the error threshold, the determination module 202 determines to directly connect the TV receiver 100 to another communication device without through the wireless relay device 150. The determination module 202 of the embodiment also determines whether a time interval from when a RTC packet is transmitted until a CTS packet is received is equal to or more than a predetermined interval threshold. If the time interval is equal to or more than the interval threshold, the determination module 202 determines to directly connect the TV receiver 100 to another communication device without through the wireless relay device 150. The error threshold is determined in advance as a reference to make a determination regarding the number of errors. The interval threshold is determined in advance as a reference time interval when the wireless relay device 150 is congested.

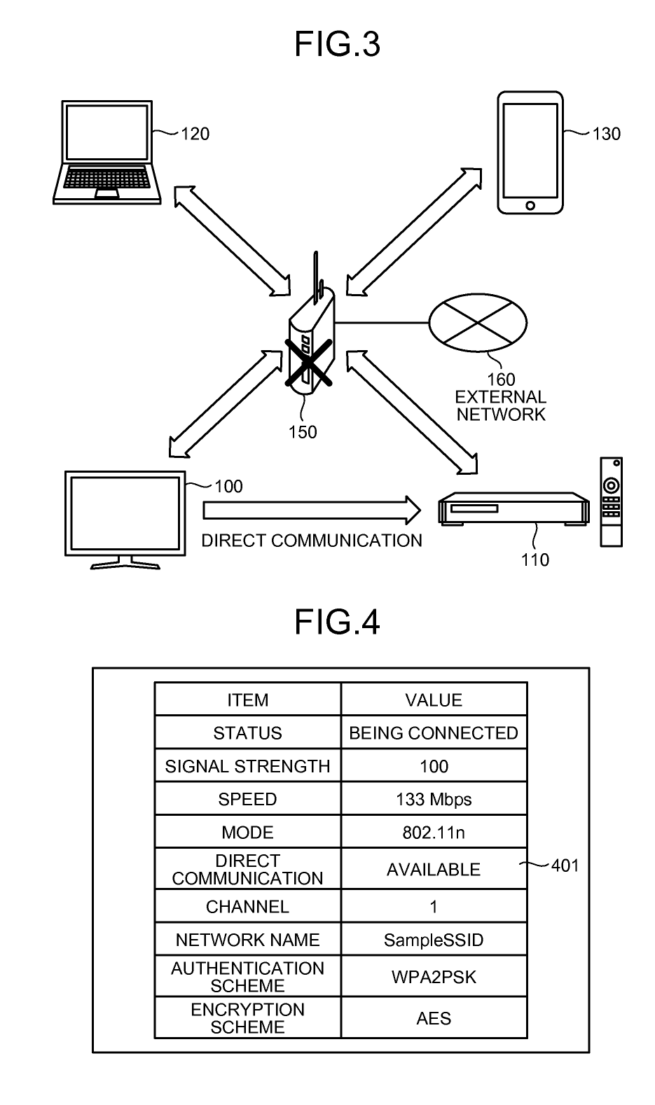

FIG. 3 is a schematic diagram for explaining direct communication by the TV receiver 100. In the example of FIG. 3, the TV receiver 100 has been exchanging data with the content recorder 110 via the wireless relay device 150. Meanwhile, the wireless relay device 150 is exchanging data also with the PC 120 and the mobile terminal 130, which imposes a heavy load on the wireless relay device 150. In another case, there is interference with communication between the TV receiver 100 and the wireless relay device 150. Accordingly, the determination module 202 determines that the congestion is at the predetermined level or more. Thus, the TV receiver 100 transmits data to the content recorder 110 through direct communication.

To transmit data to the external network 160 while the TV receiver 100 is performing direct communication with another communication device, the transmitter 204 of the TV receiver 100 switches the connection destination to the wireless relay device 150 via the wireless connection I/F 212. With this, the TV receiver 100 can transmit data to the external network 160.

As described above, while performing direct communication, the TV receiver 100 is required to change the connection destination depending on the transmission destination. To change the connection destination, it is necessary to hold the correspondence relationship between the transmission destination and the connection destination as information, and change the transmission destination according to a packet. Such process imposes a heavy processing load on a communication device not having rich functions. In view of this, in the embodiment, the TV receiver 100 uniformly transmits data to the wireless relay device 150 when the wireless relay device 150 is not congested to reduce the processing load. Only when the wireless relay device 150 is congested, the TV receiver 100 is connected to another communication device for direct communication.

The packet generator 207 generates a packet to be transmitted. For example, the packet generator 207 reads content stored in the content storage module 209 and generates a transmission packet from the content. When direct communication is to be performed through the transmitter 204, the packet generator 207 generates a packet for direct communication (hereinafter, “direct communication packet”). For example, in the case of direct communication, the packet generator 207 sets a flag indicating direct communication in the header of the packet. Thus, a communication device that receives the packet can determine whether the packet is transmitted through direct communication.

When the determination module 202 determines that the congestion level is lower than the predetermined reference level, the transmitter 204 transmits the generated packet to the wireless relay device 150 together with an address indicating a communication device as a transmission destination and the like. In this manner, data is transmitted to the communicating device as a transmission destination through the wireless relay device 150.

On the other hand, when the determination module 202 determines that the congestion level reaches or is above the predetermined reference level, the transmitter 204 directly transmits the packet to the communicating device as a transmission destination without through the wireless relay device 150. At this time, the transmitter 204 transmits the direct communication packet generated by the packet generator 207.

The receiver 203 receives data from the wireless relay device 150 by a normal packet. The receiver 203 also receives data from another communication device by a direct communication packet.

The packet processor 208 processes the normal packet or the direct communication packet received by the receiver 203.

Upon transmitting data to another communication device after the receiver 203 receives a direct communication packet from the communication device, the transmitter 204 first accesses the wireless relay device 150 to transmit the data via the wireless relay device 150. Considering that direct communication is being performed, it is expected that the wireless relay device 150 is already carrying a heavy load. Accordingly, the determination module 202 determines that the load on the wireless relay device 150 is heavy, and thereby the transmitter 204 transmits data to the communication device through the direct communication.

The display controller 201 displays various types of information on the screen (not illustrated) of the TV receiver 100. For example, the display controller 201 displays content stored in the content storage module 209.

In response to a predetermined operation by the user, the display controller 201 displays information on the communication state. FIG. 4 illustrates an example of a screen displayed by the display controller 201. As illustrated in FIG. 4, the display controller 201 displays the current connection state of the TV receiver 100. Referring to an item 401 in FIG. 4, the user can check whether “direct communication” is “available”. That is, if “direct communication” is “available”, it means that the TV receiver 100 can directly communicate with another communication device without through the wireless relay device 150. Thus, the user can confirm that the load on the wireless relay device 150 can be reduced.

More specifically, when the transmitter 204 transmits data to another communication device without through the wireless relay device 150, the display controller 201 displays that “direct communication” is “available”. When the transmitter 204 transmits data to another communication device through the wireless relay device 150 regardless of the load on the wireless relay device 150, the display controller 201 displays that “direct communication” is “unavailable”. The user may set “direct communication” to “available” or “unavailable”.

Incidentally, the content recorder 110, the PC 120, and the mobile terminal 130 also comprises the display controller 201, the determination module 202, the receiver 203, the transmitter 204, the error acquisition module 205, the transmission interval acquisition module 206, the packet generator 207, the packet processor 208, the transmission interval storage module 210, the error storage module 211, and the wireless connection I/F 212. That is, the content recorder 110, the PC 120, and the mobile terminal 130 are of basically the same configuration as previously described for the TV receiver 100, and the configuration will not be described again.

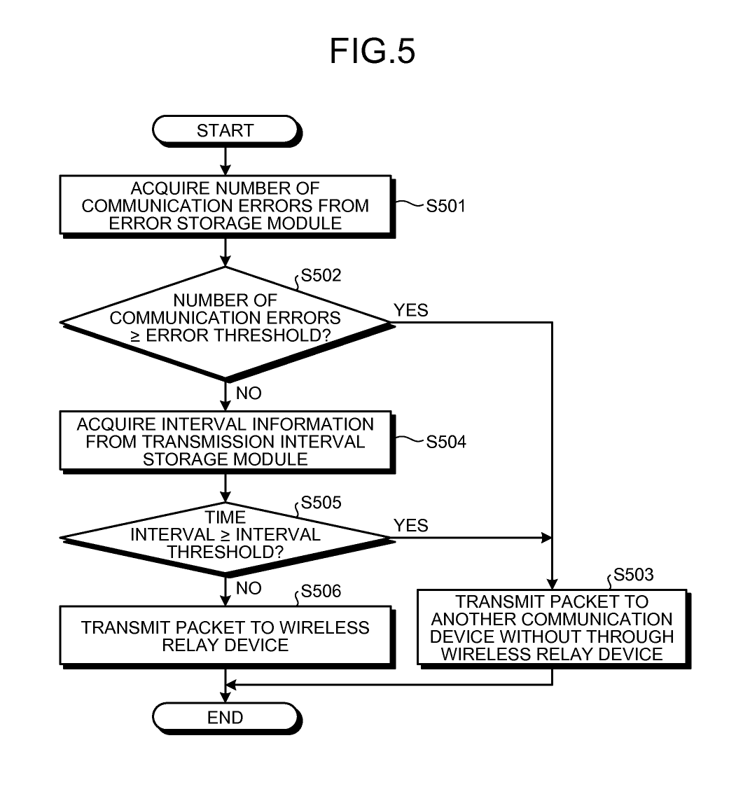

In the following, a description will be given of the operation of the TV receiver 100 to determine how to transmit a packet in the embodiment. FIG. 5 is a flowchart of the operation of the TV receiver 100 to determine how to transmit a packet in the embodiment.

First, the determination module 202 acquires the number of communication (transmission and reception) errors that have occurred between the TV receiver 100 and the wireless relay device 150 within a predetermined time period from the present time from the error storage module 211 (S501).

Next, the determination module 202 determines whether the number of communication errors is equal to or more than the error threshold (S502). If the number of communication errors is equal to or more than the error threshold (Yes at S502), the determination module 202 determines to directly transmit a packet to another communication device without through the wireless relay device 150 (S503).

On the other hand, if the number of communication errors is less than the error threshold (No at S502), the determination module 202 acquires interval information from the transmission interval storage module 210 (S504).

After that, the determination module 202 determines whether a time interval indicated by the interval information is equal to or more than the predetermined interval threshold (S505). If the time interval is equal to or more than the interval threshold (Yes at S505), the determination module 202 determines to directly transmit a packet to another communication device without through the wireless relay device 150 (S503)

On the other hand, if the time interval is less than the interval threshold (No at S505), the determination module 202 determines to transmit a normal packet to the wireless relay device 150 (S506).

Depending on the transmission destination determined as above, the packet generator 207 generates a packet, and the transmitter 204 transmits the packet.

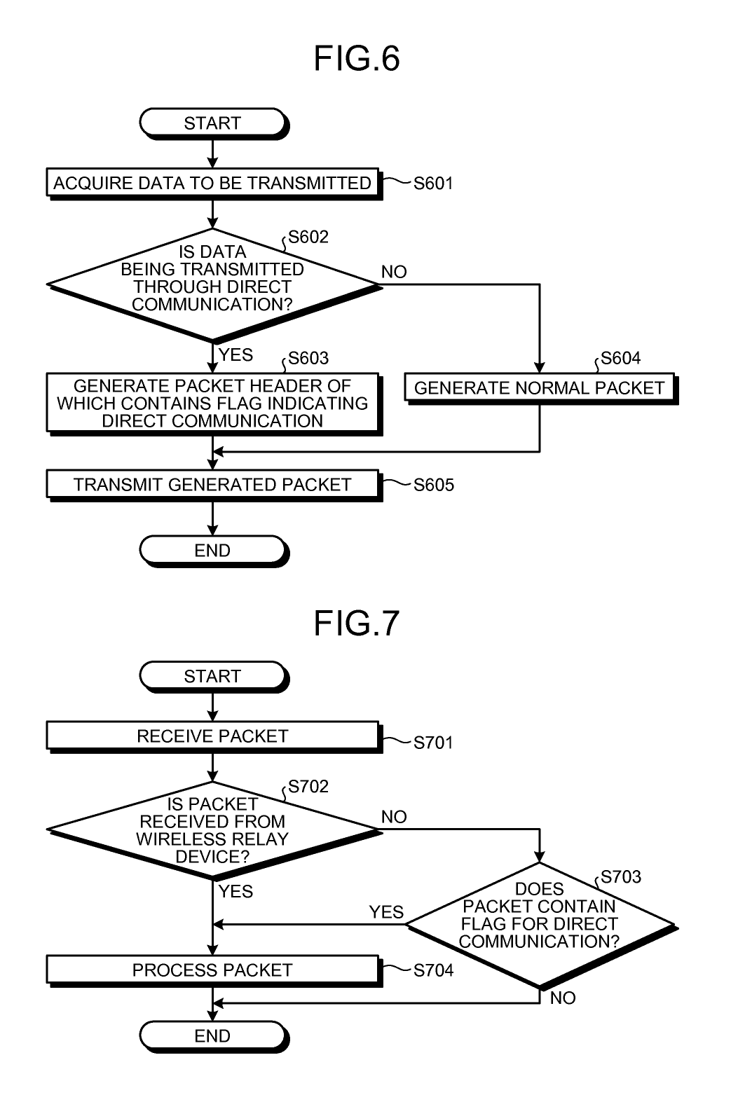

In the following, a description will be given of the operation of the TV receiver 100 to transmit a packet in the embodiment. FIG. 6 is a flowchart of the operation of the TV receiver 100 to transmit a packet in the embodiment. It is herein assumed that a determination has already been made by the process of FIG. 5 as to whether to directly transmit a packet.

First, the packet generator 207 acquires data to be transmitted (S601). Examples of the data include content stored in the content storage module 209 and the like.

The packet generator 207 then determines whether data is being transmitted through direct communication based on the determination result of the determination module 202 (S602). Having determined that data is not being transmitted through direct communication (No at S604), the packet generator 207 generates a normal packet (S604). The term “normal packet” as used herein refers to a packet to be transmitted to the wireless relay device 150.

On the other hand, having determined that data is being transmitted through direct communication (Yes at S604), the packet generator 207 generates a packed the header of which contains a flag indicating direct communication (S603).

The transmitter 204 transmits the generated packet to the wireless relay device 150 or another communication device (for example, the content recorder 110) based on the determination result of the determination module 202 (S605). With this, if the packet is a normal packet, the packet is transmitted to the communication device through the wireless relay device 150. If the packet is a direct communication packet, the packet is transmitted to the communication device not through the wireless relay device 150.

The packet thus transmitted is received by the communication device. In the following, a description will be given of the process upon receipt of a packet. While an example will be described in which the TV receiver 100 receives a packet, other communication devices operate in the same manner as described below.

A description will be given of the operation of the TV receiver 100 upon receipt of a packet in the embodiment. FIG. 7 is a flowchart of the operation of the TV receiver 100 upon receipt of a packet in the embodiment.

First, the receiver 203 of the TV receiver 100 receives a packet via the wireless connection I/F 212 (S701).

The receiver 203 determines whether the packet is received from the wireless relay device 150 (S702). When the packet is received from the wireless relay device 150 (Yes at S702), the packet processor 208 processes the packet (S704).

On the other hand, having determined that the packet is not received from the wireless relay device 150 (No at S702), the receiver 203 determines whether the packet contains a flag for direct communication (S703). When the packet does not contain a flag for direct communication (No at S703), the process ends.

On the other hand, when the packet contains a flag for direct communication (Yes at S703), the packet processor 208 processes the packet (S704).

In this manner, a packet received through the wireless relay device 150 or a packet directly received from another communication device is processed.

While the operation of the TV receiver 100 is described above by way of example, the same process may be performed by the PC 120, the mobile terminal 130, the content recorder 110, and the like. Further, in addition to the PC 120, the mobile terminal 130, and the content recorder 110, the embodiment may be applied to any communication device capable of communication via the wireless communication line.

As described above, according to the embodiment, the TV receiver 100 measures a time interval until a CTS packet is received and the number of retries due to transmission error to estimate the load on the wireless relay device 150 and the level of interference. Thus, the TV receiver 100 switches, if necessary, communication mode between relay communication via the wireless relay device 150 and direct communication with another communication device. This reduces the load on the wireless relay device 150. Moreover, the operational load on the user can be reduced since he/she is not required to specify the settings to switch communication mode, and the convenience is improved.

According to the embodiment, the TV receiver 100 and the like can directly receive content from another communication device. This reduces communication interference and the load on the wireless relay device 150 and improves speed of communication with another communication device compared to relay communication through the wireless relay device 150. Thus, the user can enjoy content transferred seamlessly unaware of it.

The embodiment is susceptible to various modifications and alternative forms. An examples of such modifications will be described below.

In the embodiment described above, even when receiving a direct communication packet, the communication device first tries to transmit the packet through the wireless relay device 150; however, it is not so limited. An example will be described as a modification in which, when a direct communication packet is received, a packet is transmitted through direct communication. In the modification, the TV receiver 100 will be described as an example of the communication device. The TV receiver 100 of the modification is of basically the same configuration as previously described in the embodiment.

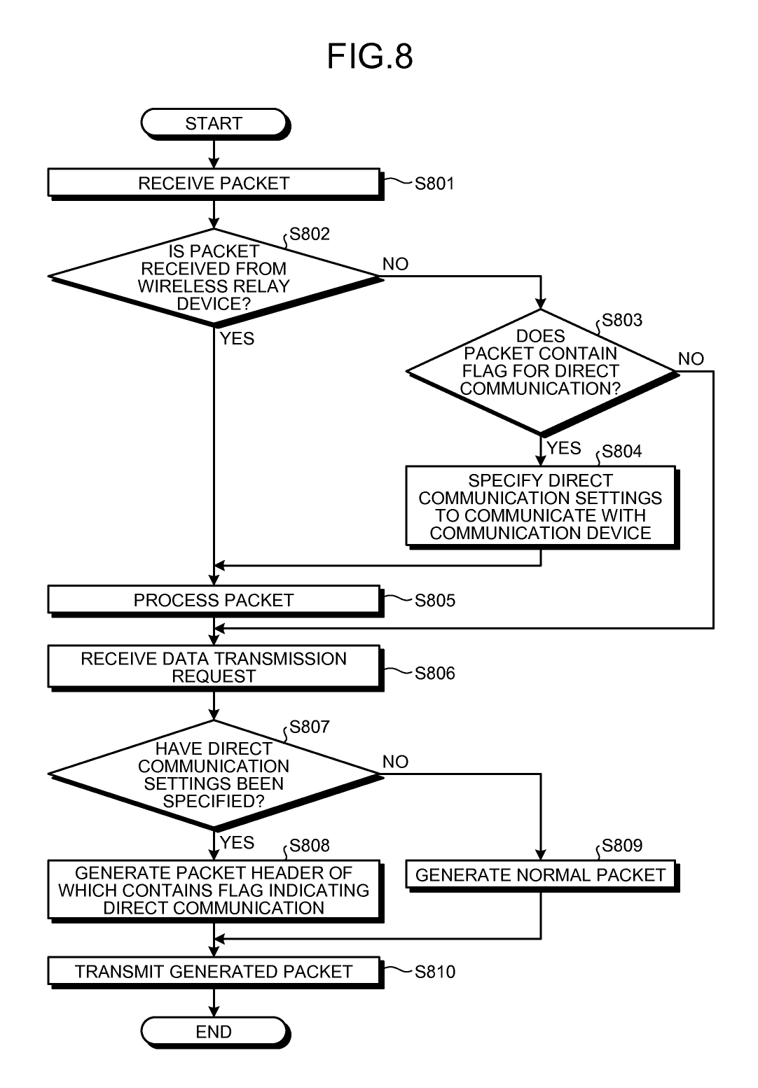

A description will be given of the operation of the TV receiver 100 to transmit/receive a packet in the modification. FIG. 8 is a flowchart of the operation of the TV receiver 100 to transmit/receive a packet in the modification.

First, the receiver 203 receives a packet from at least one of the wireless relay device 150 or another communication device connected via the wireless connection I/F 212 (S801).

The receiver 203 then determines whether the packet is received from the wireless relay device 150 (S802). When the packet is received from the wireless relay device 150 (Yes at S802), the packet processor 208 processes the packet (S805).

On the other hand, having determined that the packet is not received from the wireless relay device 150 (No at S802), the receiver 203 determines whether the packet contains a flag for direct communication (S803). When the packet does not contain a flag for direct communication (No at S803), the process moves to S806.

On the other hand, when the receiver 203 determines that the packet contains a flag for direct communication (Yes at S803), settings are specified so that, upon data transmission to the communication device as a transmission source, data is transmitted through direct communication (S804). After that, the packet processor 208 processes the packet (S805).

A data transmission request is received from the communication device from which the packet is received at S801 (S806).

The packet generator 207 determines whether the settings have been specified for direct communication (S807).

Having determined that settings have not been specified for direct communication (No at S807), the packet generator 207 generates a normal packet (S809).

On the other hand, having determined that settings have been specified for direct communication (Yes at S807), the packet generator 207 generates a packed the header of which contains a flag indicating direct communication (S808).

The transmitter 204 transmits the generated packet (S810). With this, if the packet is a normal packet, the packet is transmitted to the communication device through the wireless relay device 150. If the packet is a direct communication packet, the packet is transmitted to the communication device not through the wireless relay device 150.

In this manner, in the TV receiver 100, when the receiver 203 receives a direct communication packet, the transmitter 204 directly transmits data to a communication device without through the wireless relay device 150.

As described above, according to the modification, when receiving a direct communication packet, the TV receiver 100 directly transmits a packet to a communication device through direct communication without inquiring the wireless relay device 150. Thus, it is possible to further reduce the processing load on the wireless relay device 150 and improve the response speed as well as achieving the same effect as the first embodiment.

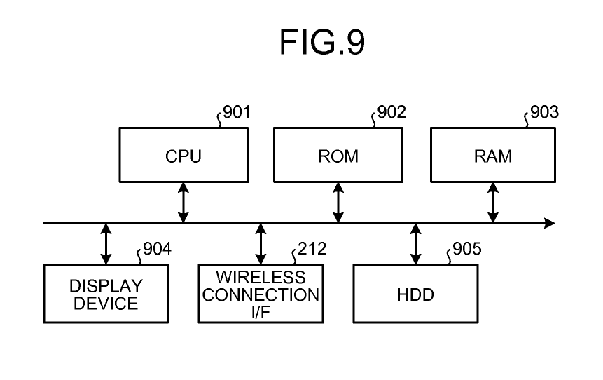

FIG. 9 is a block diagram of a hardware configuration of the TV receiver and other communication devices of the embodiment and the modification thereof to control the wireless communication.

The TV receiver comprises, in addition to a hardware configuration of a common TV receiver, a central processing unit (CPU) 901, a read only memory (ROM) 902, a random access memory (RAM) 903, a hard disk drive (HDD) 905, the wireless connection I/F 212, and a display device 904.

A computer program may be executed on a computer to realize the same function as the TV receiver and other communication devices of the embodiment and the modification thereof. The compute program may be stored in a computer connected via a network such as the Internet so that it can be downloaded therefrom via the network. The compute program may also be provide or distributed via a network such as the Internet.

The compute program may be provided as being stored in advance in ROM or the like.

The compute program comprises modules that implement the above constituent elements (the display controller, the determination module, the receiver, the transmitter, the error acquisition module, the transmission interval acquisition module, the packet generator, the packet processor). As real hardware, the CPU loads the compute program from the storage medium as described above into the main memory and executes it. With this, the display controller, the determination module, the receiver, the transmitter, the error acquisition module, the transmission interval acquisition module, the packet generator, and the packet processor are implemented on the main memory or the RAM.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication processor comprising:
a connection controller configured to connect to at least one of a communication relay device and a communication device via wireless communication, the communication relay device being configured to communicate data with the communication device connected to a network;
an acquisition module configured to acquire traffic information indicating a traffic level while the connection controller is connected to the communication relay device; and
a transmitter configured to transmit data to the communication device through the communication relay device when the traffic level is lower than a first level, and to transmit the data to the communication device bypassing the communication relay device when the traffic level is equal to or higher than the first level.

2. The communication processor of claim 1, wherein the acquisition module is configured to acquire at least one of a response time from a communication request to the communication relay device to a receipt of a response, and a number of retries due to errors in transmissions to the communication relay device as the traffic information.

3. The communication processor of claim 1, further comprising a receiver configured to receive data from at least one of the communication relay device and the communication device, wherein
when the receiver receives the data from the communication device bypassing the communication relay device, the transmitter is configured to transmit data to the communication device bypassing the communication relay device.

4. The communication processor of claim 1, further comprising a display module configured to display whether data can be transmitted to the communication device bypassing the communication relay device.

5. A communication processor comprising:
a connection controller configured to connect to at least one of a communication relay device and a communication device via wireless communication, the communication relay device being configured to communicate data with the communication device connected to a network;
a receiver configured to receive data from at least one of the communication relay device and the communication device; and
a transmitter configured to transmit data to the communication device bypassing the communication relay device, when the receiver receives the data from the communication device bypassing the communication relay device.

6. The communication processor of claim 5, further comprising:
an acquisition module configured to acquire traffic information indicating a traffic level while the connection controller is connected to the communication relay device;
wherein the transmitter is configured to transmit data to the communication device according to the traffic level.

7. The communication processor of claim 5, further comprising a display module configured to display information indicative of whether data can be transmitted to the communication device bypassing the communication relay device.

8. A communication processing method applied to a communication processor, the communication processing method comprising:
transmitting data to a communication device either bypassing a communication relay device that communicates data with a communication device connected to a network via wireless communication, or via the communication relay device; and
displaying whether the data is transmitted to the communication device bypassing the communication relay device depending on whether the data is transmitted to the communication device or the communication relay device at the transmitting.

9. The communication processing method of claim 8, further comprising:
acquiring traffic information indicating a traffic level while the connection controller is connected to the communication relay device; and
determining whether transmitting the data to the communication device is through the communication relay device or bypassing the communication relay device, according to the traffic level.

10. The communication processing method of claim 8, further comprising:
receiving data from at least one of the communication relay device and the communication device, wherein
when the receiver receives the data from the communication device bypassing the communication relay device, the transmitter is configured to transmit data to the communication device bypassing the communication relay device.
